(19) United States
(12) Patent Application Publication
(10) Pub. No.: US 2008/0091883 A1
(43) Pub. Date: Apr. 17, 2008

(54) Load starvation detector and buster

(75) Inventors: Jason A. Cox, Raleigh, NC (US); Eric F. Robinson, Raleigh, NC (US); Thuong Q. Truong, Austin, TX (US); Mark J. Wolski, Apex, NC (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/548,820

(22) Filed: Oct. 12, 2006

(51) Int. Cl. G06F 12/00

(52) U.S. Cl. 711/130

(57) ABSTRACT

A system for detecting and breaking up requester starvation, including: a plurality of logic circuits, each of the plurality of logic circuits permitted to access a cache via a plurality of requesters for requesting information from the cache; and a counter for counting a number of times each of the plurality of requestors of each of the plurality of logic circuits has (i) successfully accessed one or more of a plurality of arbitration levels and (ii) has been rejected by a subsequent arbitration level; wherein when the counter reaches a predetermined threshold value, an event is triggered to block a first type of requester from accessing the cache and to permit a second type of requester to access the cache; and wherein the counter is reconfigured to count a predetermined number of cycles before the first type of requester is unblocked from accessing the cache.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to logic circuits, and particularly to a method for detecting and breaking up load starvation.

2. Description of Background

In a head-to-head arbitration between load and store commands, a situation may arise where a store command prevents a load command from winning arbitration. In other words, when one or more commands request information from a cache, the cache determines whether to accept one command over the other. A situation may arise where store commands are continuously accepted by the cache, thus ignoring the load commands altogether. The reason for such an occurrence could be due to the elevated priority for the store, or a case where the load runs into a resource conflict (e.g., Least Recently Used (LRU) access) with a store which recently won arbitration.

It is possible for these “store beats load” conditions to persist for a very long period of time such that loads are starved. This is not a live lock, but load throughput could be severely limited. In a multiprocessor or multi-thread system, this could also lead to starvation of a thread and unbalanced thread performance.

One “solution” is to use a round-robin technique without priority to guarantee equal access to the arbitration. However, this would not successfully resolve potential conflicts. In some situations, it is preferred to give priority to a resource if it is markedly busier than another resource.

Another solution is to leave things as is and keep a normal arbitration in place with the hope that eventually, the store stream which is impeding the load ends or changes in such a way as to enable loads to make forward progress. This is not an unrealistic expectation. However, it causes hiccups in the performance of the processor(s) waiting on the result of the load. The processor eventually is unable to make forward progress until the result of the load is returned.

Considering the limitations of requestors accessing cache, it is desirable, therefore, to formulate a method for detecting and preventing load starvation.

### SUMMARY OF THE INVENTION

The shortcomings of the prior art are overcome and additional advantages are provided through the provision of a system for detecting and breaking up requester starvation, the system comprising: a plurality of logic circuits, each of the plurality of logic circuits permitted to access a cache via a plurality of requesters for requesting information from the cache; and a counter for counting a number of times each of the plurality of requesters of each of the plurality of logic circuits has (i) successfully accessed one or more of a plurality of arbitration levels and (ii) has been rejected by a subsequent arbitration level; wherein when the counter reaches a predetermined threshold value, an event is triggered to block a first type of requester from accessing the cache and to permit a second type of requester to access the cache; and wherein the counter is reconfigured to count a predetermined number of cycles before the first type of requester is unblocked from accessing the cache.

The shortcomings of the prior art are overcome and additional advantages are provided through the provision of a method for detecting and breaking up requestor starvation in a system having: a plurality of logic circuits, each of the plurality of logic circuits permitted to access a cache via a plurality of requestors for requesting information from the cache; and a counter for counting a number of times each of the plurality of requestors of each of the plurality of logic circuits has (i) successfully accessed one or more of a plurality of arbitration levels and (ii) has been rejected by a subsequent arbitration level, the method comprising: triggering an event when the counter reaches a predetermined threshold value to block a first type of requestor from accessing the cache and to permit a second type of requestor to access the cache; and reconfiguring the counter to count a predetermined number of cycles before the first type of requester is unblocked from accessing the cache.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for a method for detecting and preventing load starvation.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic diagram illustrating one example of an N requester arbitration where there is a load request and a store request;

FIG. 2 is a system diagram illustrating one example of detecting and breaking up of the requestor starvation process; and

FIG. 3 is a flowchart illustrating one example of detecting and breaking up of the requester starvation process.

### DETAILED DESCRIPTION OF THE INVENTION

One aspect of the exemplary embodiments is a method for detecting and preventing load starvation. In another exemplary embodiment, an “impending load starvation” counter is employed to count the number of times a load request is blocked by a store request with higher priority or a previously dispatched store which has a resource conflict with the load.

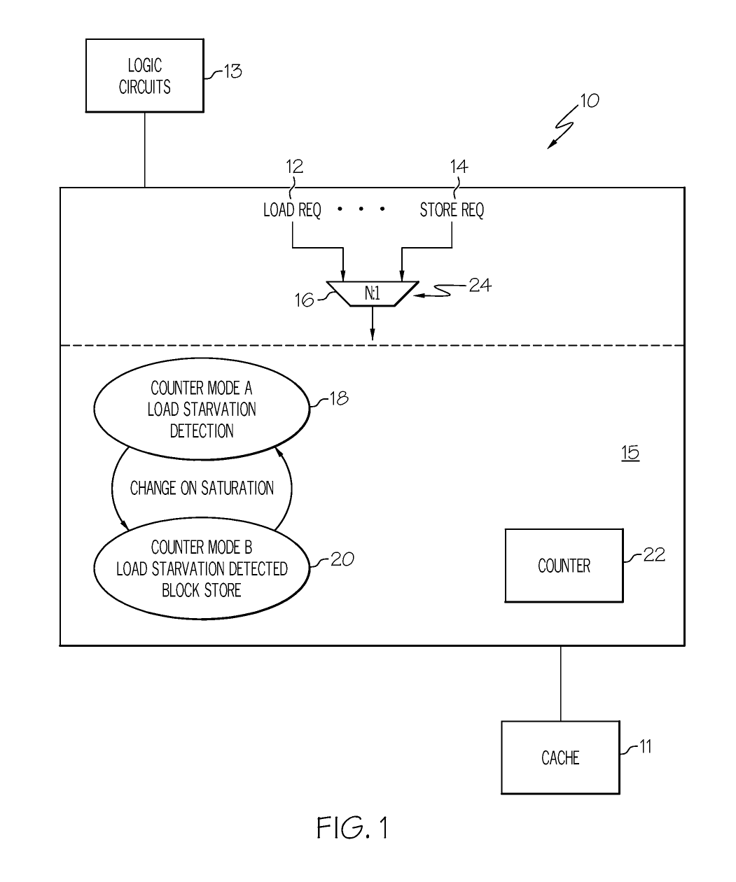

FIG. 1 illustrates one example of an N requester arbitration where there is a load request and a store request. In system 10, there are two types of requests transmitted from a plurality of logic circuits 13. One request is a load request 12 and another request is a store request 14. One skilled in the art may manipulate a number of different requests. The load request information 12 and the store request information 14 are transmitted to a mux 16 that selects either the store request information or the load request information as selected by the arbitration winner 24. The output of the mux 16 is the information needed (e.g., address) to access the cache 11. The block depicted between the logic circuits 13 and cache 11 that surrounds elements 12-24 is considered to be an arbitration unit 15. Furthermore, in system 10, the exemplary embodiments of the present invention have one counter 22, which has two counting modes. These modes are counter mode A (18) and counter mode B (20). In Mode A, the counter 22 detects a load starvation. Mode A would increment whenever a load loses arbitration and resets whenever a load wins arbitration. When the counter 22 reaches a threshold, “stores” are blocked from winning arbitration and the counter 22 switches to Mode B. In Mode B, the counter 22 increments every cycle and does not reset before saturation. When the counter 22 reaches the threshold, arbitration returns to normal operation and the counter 22 returns to Mode A.

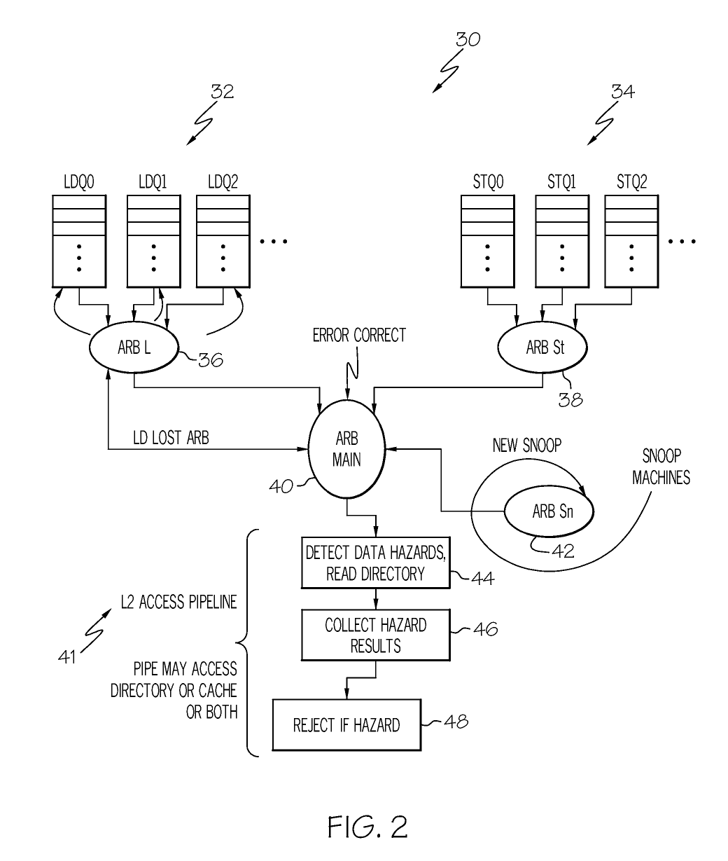

Referring to FIG. 2, there is shown a schematic diagram of a system 30 illustrating one example of detecting and breaking up of the requestor starvation process. The system 30 includes two sets of queues, load queues 32 and store queues 34. The load queues 32 provide their output to a load arbitration level 36. The store queues 34 provide their output to a store arbitration level 38. The queues in the load arbitration level 36, the store arbitration level 38, and the snoop arbitration level 42 are sent to a main arbitration level 40. The output of the main arbitration level 40 is provided to an L2 access pipeline 41, which includes the functions detect data hazards 44, collect hazard results 46, and reject if hazard is detected 48.

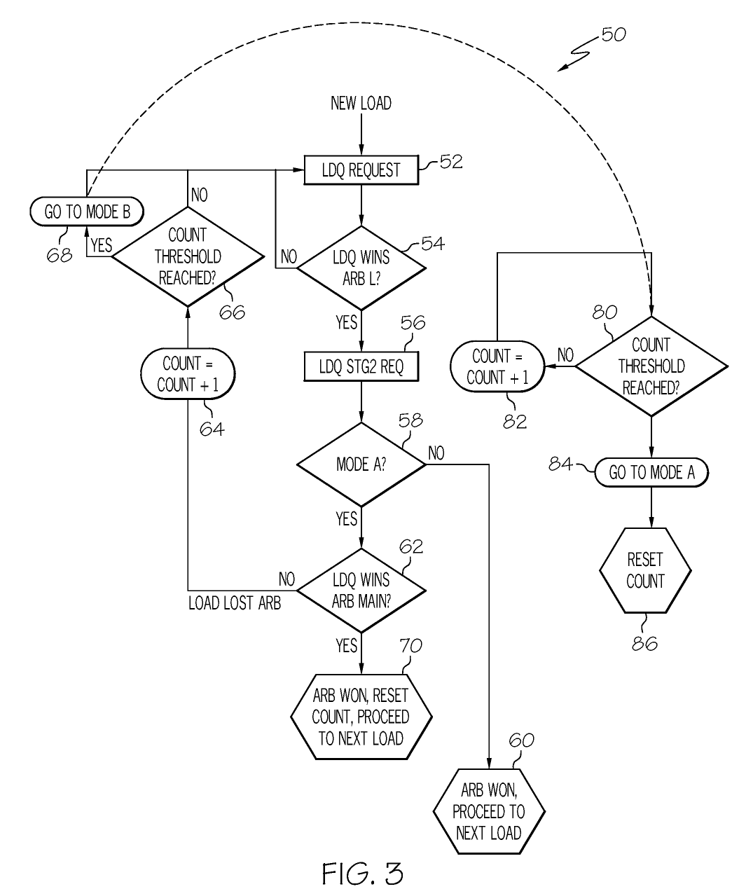

Referring to FIG. 3, there is shown a flowchart illustrating one example of detecting and breaking up of the requester starvation process. The requester starvation process flowchart 50 includes the following steps. In step 52, a new load (or requester) is provided to the load request queue. In step 54, it is determined whether the load request wins arbitration at the Arb L level 36 of FIG. 2. If the load request does not win arbitration, then the process flows back to step 52, where new loads are provided. If the load request does win arbitration, then the process flows to step 56. In step 56, the load request enters into a second stage of requesting access from a cache. In step 58, it is determined whether the counter 22 of FIG. 1 is in Mode A. If the counter 22 is not in Mode A, then the process flows to step 60. In step 60, it is determined that the load request has won arbitration and the process commences at step 52 where another load request is processed. However, if the counter 22 is in Mode A, the process flows to step 62. In step 62, it is determined whether the load request has won arbitration at the main arbitration level 40 of FIG. 2. If the load request has won arbitration at the main arbitration level 40, the process flows to step 70. In step 70, it is determined that the load request has won arbitration, the counter 22 resets, and the process commences at step 52 where another load request is processed. If the load request has not won arbitration at the main arbitration level 40, the process flows to step 64. In step 64, the counter is incremented by one integer value. In step 66, it is determined if the counter threshold has been reached. If the counter threshold has not been reached, the process flows to step 52 where another load request is processed. If the counter threshold has been reached, the process flows to step 68. In step 68, the counter goes into Mode B. In this stage, load requests become high priority, thus effectively blocking store requests from winning arbitration for a predetermined number of cycles. Once in Mode B, the process flows to step 52 where another load request is processed. Moreover, in Mode B, the counter 22 increments every cycle until the threshold is reached.

The counter threshold could be set in any of a variety of ways. For instance, it could be a static number, determined by the implementer (e.g., a system administrator, a hardware or software designer, etc.), a user-set value, or a randomly set value, which changes completely independent of the operation of the machine. In the case of a random number, a user or the implementer may select a range of values within which the randomly selected threshold could fall.

As a result, the exemplary embodiments of the present invention employ a counter to count the number of times a load request is blocked by a store request with higher priority or a previously dispatched store which has a resource conflict with the load. Either of these scenarios may result in the load losing arbitration. Once the counter reaches a certain threshold, it triggers an event that blocks stores from winning arbitration and gives loads a better chance to win arbitration. The counter is then re-configured to count a pre-specified number of cycles. When the counter times out, stores are no longer blocked from winning arbitration. One advantage of this solution is that the possible performance degradation due to blocking out the stores is only temporary. The case only arises when the load's starvation is starting to occur. At all other times, the arbiters are able to perform as normal.

Consequently, the exemplary embodiments of the present invention add a load starvation detector which attempts to detect when loads are being starved by stores. When a possible load starvation is detected, priority is changed so that stores are blocked from winning arbitration. After a period of time has passed, the load is able to make forward progress and the arbitration reverts back to the normal scheme.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for detecting and breaking up requestor starvation, the system comprising:
a plurality of logic circuits, each of the plurality of logic circuits permitted to access a cache via a plurality of requestors for requesting information from the cache; and
a counter for counting a number of times each of the plurality of requesters of each of the plurality of logic circuits has (i) successfully accessed one or more of a plurality of arbitration levels and (ii) has been rejected by a subsequent arbitration level;
wherein when the counter reaches a predetermined threshold value, an event is triggered to block a first type of requestor from accessing the cache and to permit a second type of requestor to access the cache; and
wherein the counter is reconfigured to count a predetermined number of cycles before the first type of requestor is unblocked from accessing the cache.

2. The system of claim 1, wherein the first type of requestor is a store requestor.

3. The system of claim 1, wherein the second type of requestor is a load requestor.

4. The system of claim 1, wherein the predetermined threshold value is set by an implementer.

5. The system of claim 1, wherein the threshold is a user-set value.

6. The system of claim 1, wherein the threshold is a randomly set value.

7. A method for detecting and breaking up requester starvation in a system having: a plurality of logic circuits, each of the plurality of logic circuits permitted to access a cache via a plurality of requestors for requesting information from the cache; and a counter for counting a number of times each of the plurality of requestors of each of the plurality of logic circuits has (i) successfully accessed one or more of a plurality of arbitration levels and (ii) has been rejected by a subsequent arbitration level, the method comprising:
triggering an event when the counter reaches a predetermined threshold value to block a first type of requestor from accessing the cache and to permit a second type of requester to access the cache; and
reconfiguring the counter to count a predetermined number of cycles before the first type of requestor is unblocked from accessing the cache.

8. The method of claim 7, wherein the first type of requester is a store requestor.

9. The method of claim 7, wherein the second type of requester is a load requestor.

10. The method of claim 7, wherein the predetermined threshold value is set by an implementer.

11. The method of claim 7, wherein the threshold is a user-set value.

12. The method of claim 7, wherein the threshold is a randomly set value.
